(19) United States
(12) Patent Application Publication
(10) Pub. No.: US 2003/0000596 A1
(43) Pub. Date: Jan. 2, 2003

(54) Process for filling the bags of a chain of bags or a chain of stacks of bags as well as a device for carrying out the process

(76) Inventors: Hans-Ludwig Voss, Tecklenburg (DE); Ulrich Stienecker, Ladbergen (DE)

Correspondence Address: JACOBSON HOLMAN PLLC, 400 SEVENTH STREET N.W., SUITE 600, WASHINGTON, DC, 20004, US

(21) Appl. No.: 10/180,539

(22) Filed: Jun. 27, 2002

(30) Foreign Application Priority Data
Jun. 28, 2001 (DE) 101 31 451.5
Jul. 23, 2001 (DE) 101 35 760.5

(51) Int. Cl. B67C 3/00; B65B 3/04; B65B 1/04

(52) U.S. Cl. 141/10; 141/314

(57) ABSTRACT

The invention relates to a process for filling the bags of a chain of bags or a chain of stacks of bags. According to the invention, the chain of bags or the chain of stacks of bags is unwound from a reel, guided over a table, until a bag lies in a suction and filling position on said table. Then the bag is pulled up by means of a suction device, filled, and severed from the supporting web as well as transported away to a depositing table.

The invention relates to a process for filling the bags of a chain of bags or a chain of stacks of bags as well as a device for carrying out this process.

The bags to be filled in the present process are usually made of plastic, for example polyethylene. They are made of plastic films by folding and welding by a well-known method. They are delivered individually in succession to the end of the device, which manufactures the bags. In the packaging machines, where the bags are filled with arbitrary objects, the bags are not usually fed individually in succession, but rather said bags, collected in the form of a stack, are put into a corresponding bag storage of the packaging machine, from where they are removed from the respective stack and automatically moved along for filling.

In a parallel application the applicant has put under protection a novel process for collecting bags, thus forming chains of bags or chains of stacks of bags.

This development makes it possible to collect large units of chains of bags or chains of stacks of bags, which can be separated again in a simple manner.

The object of the present invention is to provide a process for filling the bags of such a novel chain of bags or chain of stacks of bags as well as a device for carrying out this process.

The invention solves this problem with a process, according to claim 1. Correspondingly the process comprises the following steps:

unwind the chain of bags or the chain of stacks of bags from a reel,

guide the chain of bags or the chain of stacks of bags over a table until a bag lies in a suction and filling position on said table,

pull up the bag by means of a suction device,

fill the bag,

sever the filled bag from the supporting web of the chain of bags or the chain of stacks of bags,

transport the bag away for further processing.

With this process for filling the bags, wherein the bags can be filled with any arbitrary material, a large number of bags can be filled quickly and efficiently without having to refill often the storage of the stacked bags. At the same time the order of sequence of the aforementioned process steps can be interchanged. The chains of bags or the chains of stacks of bags that are collected on one reel allow an almost arbitrarily large number of bags to be collected. Then they can be further processed, that is filled, at high speed.

Preferred embodiments of the process, according to the main claim, are disclosed in the dependent claims, appended to the main claim. Correspondingly the supporting web can be rewound on a reel after the filled bag has been severed from said supporting web. Furthermore, during the opening, filling and severing operation of the bag the tacking point between bag and supporting web can be fixed in position by means of a holding unit that can be raised and lowered. Thus, it is guaranteed that the bag lies in the correct fill position and that it is guaranteed that the bag is severed flawlessly from the supporting web.

Furthermore, the invention relates to a device for carrying out the aforementioned process. Said device exhibits a table, over which the chain of bags or the chain of stacks of bags can be guided, and a suction unit for opening the bag.

Preferably the table can exhibit in its end region, lying in the direction of transport of the chain of bags, a raised putting-down edge, where in the suction and filling position of the bag the tacking point of the bag comes to rest. A holding unit for holding this tacking point securely in the corresponding correct suction and filling position of the bag can comprise a holding bracket, which can be raised and lowered.

At least one photocell can be provided for accurate detection of the position of a bag of the chain of bags on the table.

Other details and advantages of the invention are explained in detail below with reference to one embodiment, depicted in the drawings.

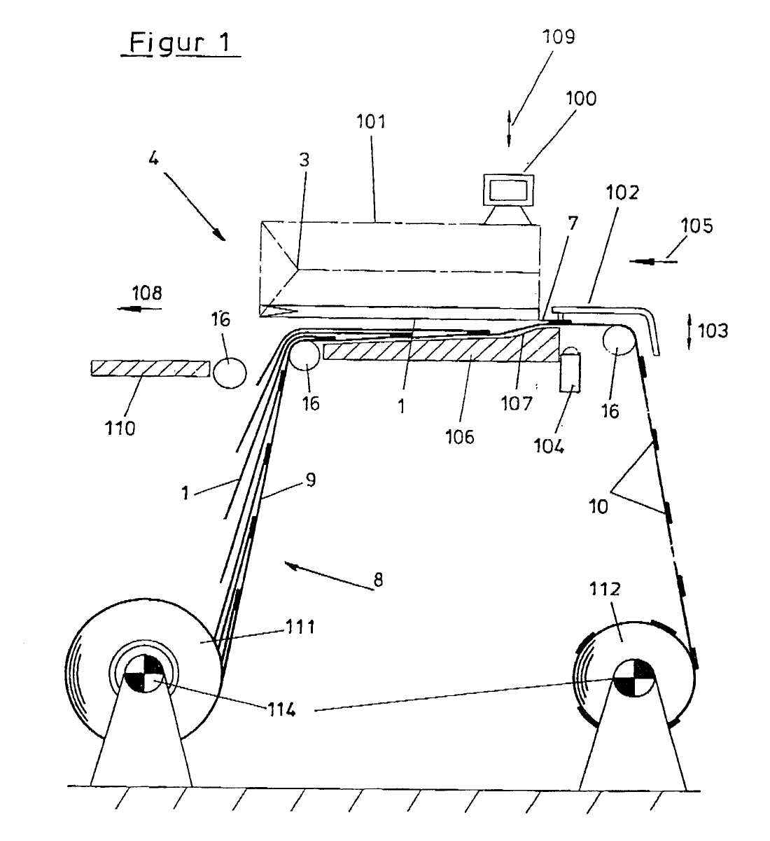

FIG. 1 is a side view of a device, according to the invention.

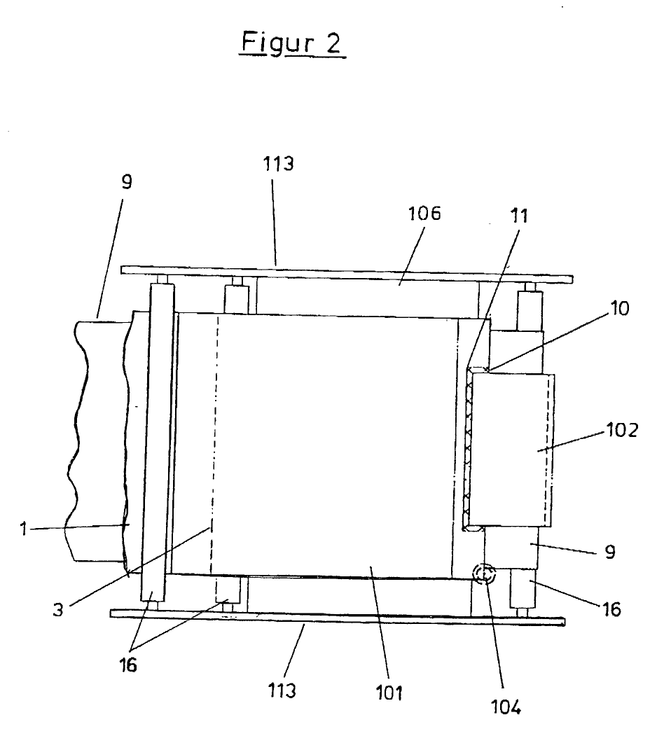

FIG. 2 is a top view of a detail of the device, depicted in FIG. 1.

In the device, depicted in FIG. 1, a chain 8 of bags is shown that exhibits bags 1, fixed in position on a supporting web 9 by means of tacking points. At the same time the bags are spaced apart in such a manner on the supporting web 9 that the result is a staggered chain of bags. The chain 8 of bags is usually delivered in the form of a reel 111, wound on a winding mandrel. In a corresponding unwinding station, the winding roll is rotated in such a manner via a drive 114 that the chain 8 of bags is unwound from the reel 111. After guiding around a deflecting roller 16, the chain of bags runs over a table 106, whose end, running in the direction of motion of the chain 8 of bags, exhibits a putting-down edge, which slopes toward the top and forms a base. As soon as a bag comes to rest in a predetermined position on the table, it is sucked in and pulled up by means of a suction unit 100, which can be moved in the direction of the double arrows 109. In FIG. 1 the folded bag is shown in the suction position by means of the continuous line. The same bag is shown as the sucked up bag 101 by means of the dashed line. In the embodiment shown here, the bag has a bottom fold 4; FIG. 1 shows the fold edge 3. In this opened position, the bag can be filled from the direction 105. The filling tools are not shown in detail in the drawing of the device, shown here. They are based, of course, on the type of material to be filled and can comprise grippers for filling piece goods, fill pushers or fill nozzles for powdery material.

The bag 1 is connected to the supporting web 9 by means of a lip 7 and a tacking point 10. The bag is securely clamped above the table 106 in the suction and fill position, but in the area of its lip 7 it is clamped by means of a holding bracket 102, which can be moved in the direction of the double arrows 103, in order to guarantee that the bag is fixed securely in the suction and fill position. The position of the holding bracket 102 is also especially evident from FIG. 2, where it is clear that said bracket grasps the bag 1 or 101 in the area of its tacking point 10 so that, when it is released from the suction and fill position, it can be severed cleanly at a tear-off perforation 11, arranged around this tacking point.

This severing operation is done by means of grippers, which are not shown in detail here and which then convey the filled bag also in the direction 108 over a roller 16 onto a table 110, which serves as a place to deposit the filled bags. From this place of deposit, the bags can be pushed onto a conveyor belt, which is not shown in detail here and which transports the filled bags away for further processing. In a frame 113, in which the table 106 is mounted, there are photocells 104 at a suitable position. As the chain 8 of bags advances, said photocells detect the position of the respective bag 1 to be positioned. As soon as the bag 1 is in the corresponding suction and fill position, a signal is sent from the photocells 104 to the drive for the holding bracket 102 so that said bracket fixes the bag at the lip 7 along the tacking point 10. At the same time the drive of the chain 8 of bags is stopped and the suction device 100 for sucking up the bag is actuated. The photocell 104 is disposed, as shown in FIG. 2, in the edge region of the supporting web 9 in order to detect the leading edge of the bag 1, projecting beyond the edge region of the supporting web 9.

The supporting web 9 is rewound together with the remaining tacking points 10, after it is guided over a deflection roller 16, onto a winding mandrel 112. The winding mandrel 112 is set rotating by means of a drive 114.

1. Process for filling the bags of a chain of bags or a chain of stacks of bags, characterized by the following steps:
unwind the chain (8) of bags or the chain of stacks of bags from a reel (111),
guide the chain (8) of bags or the chain of stacks of bags over a table (106) until a bag (1) lies in a suction and filling position on said table,
pull up the bag by means of a suction device (100),
fill the bag (1),
sever the filled bag (1) from the supporting web (9) of the chain (8) of bags or the chain of stacks of bags,
transport the bag (1) away for further processing.

2. Process, as claimed in claim 1, characterized in that, after the filled bags (1) have been severed, the supporting web (9) is wound on a reel (112).

3. Process, as claimed in claim 1 or 2, characterized in that during the opening, filling and severing operation of the bag, the tacking point (10) between bag (1) and supporting web (9) can be fixed in position by means of a holding unit (102) that can be raised and lowered.

4. Device for carrying out the process, as claimed in any one of the claims 1 to 3, characterized by a table (106), over which the chain (8) of bags or the chain of stacks of bags can be guided, and by a suction unit (100) for opening the bag (1).

5. Device, as claimed in claim 4, characterized in that the table (106) exhibits in its end region, lying in the direction of transport of the chain (8) of bags, a raised putting-down edge, where in the suction and filling position of the bag (1) the tacking point (10) of the bag comes to rest.

6. Device, as claimed in claim 4 or 5, characterized in that a holding bracket (102), which can be raised and lowered, serves as the holding unit.

7. Device, as claimed in any one of the claims 4 to 6, characterized in that at least one photocell (104) is provided for accurate detection of the position of a bag (1) of the chain (8) of bags on the table (106).
